(19) United States
(12) Patent Application Publication
(10) Pub. No.: US 2013/0199663 A1
(43) Pub. Date: Aug. 8, 2013

(54) SYSTEMS AND METHODS FOR DISPENSING MATERIALS

(71) Applicant: Bend Research, Inc., Bend, OR (US)

(72) Inventors: David Dixon Newbold, Bend, OR (US); Douglas Lee Millard, Bend, OR (US)

(73) Assignee: Bend Research, Inc., Bend, OR (US)

(21) Appl. No.: 13/757,620

(22) Filed: Feb. 1, 2013

Related U.S. Application Data
(60) Provisional application No. 61/594,912, filed on Feb. 3, 2012.

(51) Int. Cl. B67D 7/30

(52) U.S. Cl. CPC B67D 7/30
USPC 141/9; 141/83; 222/544; 222/77

(57) ABSTRACT

An exemplary system for dispensing liquid and solid materials can comprise a tank; one or more liquid feeders configured to dispense one or more liquids into the tank; a powder hopper comprising a powder inlet, a powder outlet, and a valve configured to open and close the powder outlet, the powder outlet being coupled to the tank; one or more powder feeders coupled to the powder inlet of the powder hopper; a first scale configured to measure the mass of powder dispensed into the powder hopper; a second scale configured to measure the mass of the liquids dispensed into the tank; and a control system configured to control the dispensing of liquids and powders based at least in part on the mass measurements from the first and second scales.

### CROSS-REFERENCE TO RELATED APPLICATION

This application claims the benefit of U.S. Provisional Application No. 61/594,912, which was filed on Feb. 3, 2012 and is incorporated herein by reference in its entirety.

### FIELD

This disclosure is related to systems and methods for dispensing materials, such as powders and liquids, to be mixed together.

### BACKGROUND

In various processes, powders or other solids are mixed with liquids to create a solution. The proportions of the various components can be critical, requiring high precision measuring equipment. The components are often dispensed from a large storage tank and the amount dispensed is measured by the loss in weight of the storage tank. When only a small amount of a component is dispensed, the accuracy of a loss in weight measuring system can be inaccurate due to the large weight of the storage tank. In addition, each storage tank for each component requires its own weighing device. Thus, there is a need for more precise and compact systems for dispensing materials to be mixed together.

### SUMMARY

Disclosed herein are embodiments of systems and methods for dispensing solid and liquid materials in precise proportions to create batches of selected mixtures in a just-in-time manner.

One exemplary system comprises a mixing tank, one or more liquid feeders coupled to the tank and configured to dispense one or more liquids into the tank, a powder hopper coupled to the tank for dispensing powder from the powder hopper into the tank, one or more powder feeders coupled to an inlet of the powder hopper and configured to dispense one or more powders from a bulk source into the powder hopper, a first measuring device configured to measure the amount of powder dispensed into the powder hopper, a second measuring device coupled to the tank and configured to measure the amount of the liquids dispensed into the tank, and a control system configured to control the dispensing of liquids and powder from the feeders based at least in part on the measurements from the measuring devices and to control actuation of an outlet valve of the powder hopper.

In preferred embodiments, the first measuring device comprises a first weighing device configured to measure the mass of powder dispensed into the powder hopper and the second measuring device comprises a second weighing device configured to measure the mass of the liquids dispensed into the tank. The powder hopper can be suspended below the first weighing device and measure the change in weight of the hopper, the powder in the hopper, and the valve apparatus coupled to the hopper.

In some embodiments, the system comprises an analytical device for measuring at least one property, such as pH or conductivity, of the mixture in the tank, and can provide an output signal that is in communication with the control system.

The powder hopper is preferably configured to receive powder from the powder feeders with the valve closed until the total mass of the received powder reaches a predetermined value, and then dispense the received powder into the tank when the valve is opened.

The valve can be a pinch valve configured to collapse a flexible portion of the powder hopper to prevent the flow of powder through it. The pinch valve can comprises a pair of substantially parallel, horizontally disposed clamping members positioned on opposite sides of the flexible portion of the hopper and at least one actuator configured to move the clamping members toward each other to collapse the flexible portion between the clamping members. The clamping members can be pivotally coupled to a rigid portion of the powder hopper such that the clamping members are pivotable about a common horizontal axis.

An exemplary method for dispensing materials comprises: dispensing a predetermined volume of at least one liquid into a tank from at least one bulk liquid source; closing an outlet valve of a powder hopper by pinching a flexible portion of the powder hopper such that powder is prevented from flowing through the flexible portion; dispensing at least one powder into the powder hopper from at least one bulk powder source; weighing the powder hopper and the powder dispensed into the powder hopper to determine the mass of the powder; opening the outlet valve by releasing compression pressure on the flexible portion of the powder hopper to allow the powder in the powder hopper to fall into the tank and form a mixture with the at least one liquid in the tank; and determining that at least one property of the mixture, such as pH or conductivity, in the tank is within a predetermined range.

In some such methods, dispensing a predetermined amount of at least one liquid into the tank comprises: determining the predetermined volume of the liquid to be dispensed into the tank; dispensing a first portion of the predetermined volume of the liquid into the tank based on an estimated flow rate of the liquid into the tank; determining the volume of the first portion by measuring the weight of the first portion within the tank; determining an actual flow rate of the liquid into the tank based on the determined volume of the first portion; adjusting the estimated flow rate based on the determined actual flow rate; and dispensing a second portion of the predetermined volume of the liquid into the tank based on the adjusted estimated flow rate.

Some methods can comprise dispensing a predetermined volume of at least one liquid into a tank from at least one bulk liquid source comprises; closing an outlet valve of a powder hopper by pinching a flexible portion of the powder hopper such that powder is prevented from flowing through the flexible portion; dispensing at least one powder into the powder hopper from at least one bulk powder source; weighing the powder hopper and the powder dispensed into the powder hopper to determine the mass of the powder; opening the outlet valve by releasing compression pressure on the flexible portion of the powder hopper to allow the powder in the powder hopper to fall into the tank to form a mixture with the at least one liquid; and determining that at least one property of the mixture in the tank is within a predetermined range.

The foregoing and other objects, features, and advantages of the invention will become more apparent from the following detailed description, which proceeds with reference to the accompanying figures.

### BRIEF DESCRIPTION OF THE DRAWINGS

FIG. 1 illustrates an exemplary system for dispensing liquids into a mixing tank.

FIG. 2 illustrates an exemplary system for dispensing liquids and solids into a mixing tank.

FIG. 3 is another illustration of an exemplary system for dispensing liquids and solids into a mixing tank.

FIG. 4 is a perspective view of an exemplary system for dispensing liquids and solids into a mixing tank.

FIG. 5 is a perspective view of a powder dispensing portion of the system of FIG. 4.

FIG. 6 is another view of the powder dispensing system shown in FIG. 5.

FIGS. 7 and 8 are perspective views of an exemplary powder hopper with a pinch valve.

### DETAILED DESCRIPTION

### General Considerations

For purposes of this description, certain aspects, advantages, and novel features of the embodiments of this disclosure are described herein. The disclosed methods, apparatuses, and systems should not be construed as limiting in any way. Instead, the present disclosure is directed toward all novel and nonobvious features and aspects of the various disclosed embodiments, alone and in various combinations and sub-combinations with one another. The methods, apparatuses, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “determine” and “provide” to describe the disclosed methods. These terms are high-level abstractions of the actual operations that are performed. The actual operations that correspond to these terms may vary depending on the particular implementation and are readily discernible by one of ordinary skill in the art.

As used herein, the terms “a”, “an” and “at least one” encompass one or more of the specified element. That is, if two of a particular element are present, one of these elements is also present and thus “an” element is present. The terms “a plurality of” and “plural” mean two or more of the specified element.

As used herein, the term “and/or” used between the last two of a list of elements means any one or more of the listed elements. For example, the phrase “A, B, and/or C” means “A,” “B,” “C,” “A and B,” “A and C,” “B and C” or “A, B and C.”

As used herein, the term “coupled” generally means mechanically, chemically, electrically, magnetically or otherwise coupled or linked and does not exclude the presence of intermediate elements between the coupled or associated items absent specific contrary language.

### Exemplary Systems and Methods for Dispensing Materials

Described herein are methods and systems for dispensing and mixing liquids and/or solids in precise proportions, such as in small batches just before the mixture is needed to be used in another process. The disclosed methods and systems can be more precise, simpler, less expensive, and take up less space than other material dispensing systems.

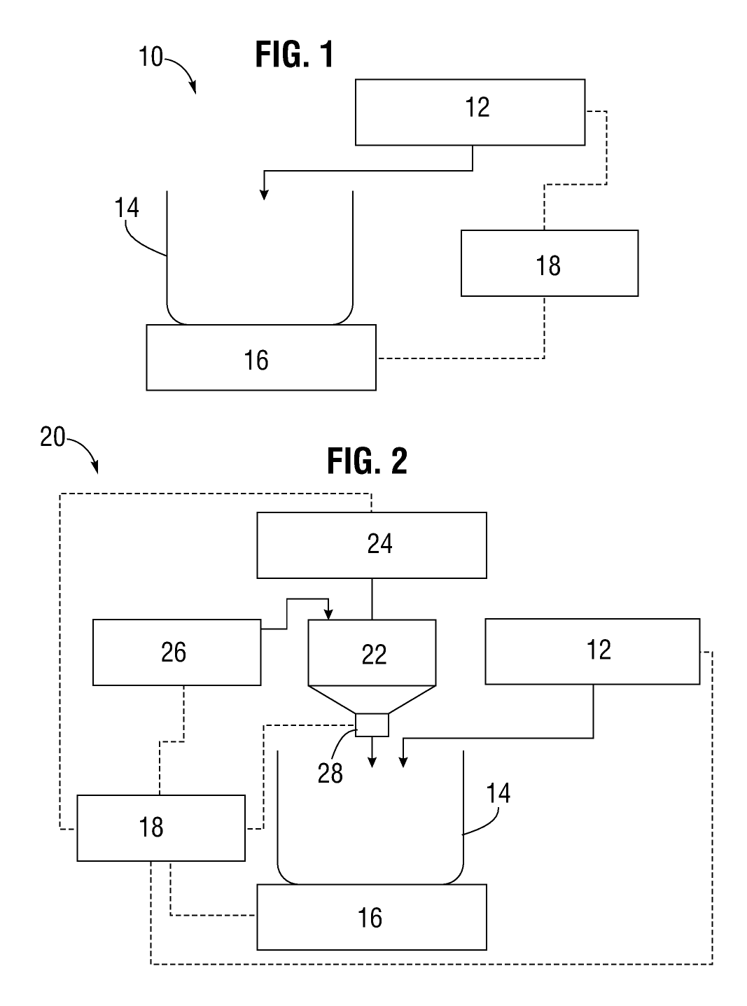

FIG. 1 shows an illustration of an exemplary system 10 for dispensing one or more liquids into a mixing tank. In this system, one or more liquids can be dispensed from one or more bulk storage tanks, or liquid feeders, 12 directly into a mixing tank 14. The mixing tank 14 can be coupled to a weighing device, or scale, 16 configured to measure the weight of the tank and its contents. A controller 18 can be coupled to both the scale 16 and the liquid feeders 12 and can control the dispensing of liquids from the liquid feeders, such as based on the change in weight of the mixing tank 14 as measured by the scale 16. The liquids dispensed from the liquid feeders 12 can comprise pure liquids, such as distilled water, or solutions, such as a salt solution, a basic solution, an acidic solution, and/or a nutrient solution, or various other fluid mixtures.

In one exemplary method, the controller 18 can control the dispensing of two or more different liquids from different liquid feeders 12 into the mixing tank 14 by sequentially dispensing each of the two liquids. For each of the different liquids, the controller can use change in weight feedback from the scale 16 to precisely dispense a desired amount. For example, if one liter of each of two liquids is to be dispensed from two different feeders 12 and mixed together in the mixing tank 14, the controller 18 can control the dispensing of a first liquid from a first of the liquid feeders 12 such that the change in weight measured by the scale 16 is equal to the weight of one liter of the first liquid. The controller 18 can be pre-programmed with the density and/or specific weight of each of the liquids being dispensed such that it can calculate the weight that corresponds to the desired volume of liquid to be dispensed. After the first liquid is dispensed, the controller 18 can repeat the process with the second liquid from the second liquid feeder 12, dispensing the second liquid into the tank 14 until the change in weight of the tank and its contents equals the weight of one liter of the second liquid.

This exemplary method of dispensing liquids can provide a more precise mixture of the two liquids because the weight of the mixing tank 14 plus small amounts of the liquids added to the tank can be more precisely measured than the loss in weight of the much heavier liquid feeders 12. Furthermore, only one scale 16 is needed, eliminating inconsistencies between plural different scales that would be needed to measure the loss in weight of each of the liquid feeders 12 and reducing the space occupied by the system and the cost and complexity of the system.

In another exemplary method related to the liquid dispensing system 10 of FIG. 1, the controller 18 can adjust the flow rate at which each liquid is dispensed out of the liquid feeders 12 and into the mixing tank 14. In such a method, the different liquids can still be dispensed one at a time in sequential order. For each of the different liquids to be dispensed, the same process can be used to precisely dispense a desired amount of that liquid. If a given volume of a liquid is to be dispensed into the mixing tank 14, the controller can allow a first portion of the given volume of liquid to be dispensed based on an estimated flow rate of the liquid. For example, if 10 liters of the liquid is to be dispensed, the controller can cause approximately 9 liters to be dispensed by dispensing the liquid at an estimated flow rate of 0.1 liter per second for 90 seconds. This first portion can be any percentage of the total volume to be dispensed, and is preferably at least 50% of the total volume. After the first portion is dispensed into the mixing tank 14, the change in weight of the mixing tank and its contents can be determined via the scale 16. From this change in weight, the actual volume of the first portion of the liquid dispensed can be calculated based on the liquid's density. For example, if the density of the liquid is 1 kg per liter and the change in weight of the mixing tank 14 after dispensing the first portion of the liquid is measured to be 8.1 kg, then the actual volume dispensed can be determined to be 8.1 liters. Based on the actual volume dispensed, the estimated flow rate can be recalculated. For example, since only 8.1 liters were dispensed rather than the estimated 9 liters, the estimated flow rate can be adjusted from 0.10 liters per second to 0.09 liters per second. Using the adjusted estimated flow rate, a second portion of the total desired volume of the liquid can be dispensed. For example, if the second portion is 1.71 liters (90% of the remaining 1.9 liters to be dispensed), the controller 18 can dispense the liquid at the adjusted estimated flow rate of 0.09 liters per second for 19 seconds. After the second portion is dispensed into the tank 14, the change in weight of the tank 14 can be measured via the scale 16 and the actual volume of the second portion that was dispensed can be determined based on the change in weight. Based on the determined actual volume of the second portion, the actual flow rate can again be calculated and the estimated flow rate can again be adjusted to match the actual flow rate. This process can be repeated until the actual volume of the liquid dispensed into the tank 14 is within a desired tolerance from the total desired volume to be dispensed.

FIGS. 2-4 show illustrations of an exemplary system 20 for dispensing and mixing one or more powders and one or more liquids. As used herein, the term powder means any substantially dry, granular material. The system 20 can comprise one or more liquid feeders 12, the mixing tank 14, the scale 16, and the controller 18 from the system 10 of FIG. 1. In addition, the system 20 can further comprise one or more powder feeders 26, a powder hopper 22 with a lower outlet valve 28, and a powder hopper scale 24. The powder hopper 22 can be suspended from the scale 24 such that the scale 24 can measure the change in weight of the hopper 22 and its powder contents. The controller 18 can control the dispensing of powder from the powder feeders 26 into the powder hopper 22, and can control the opening and closing of the valve 28.

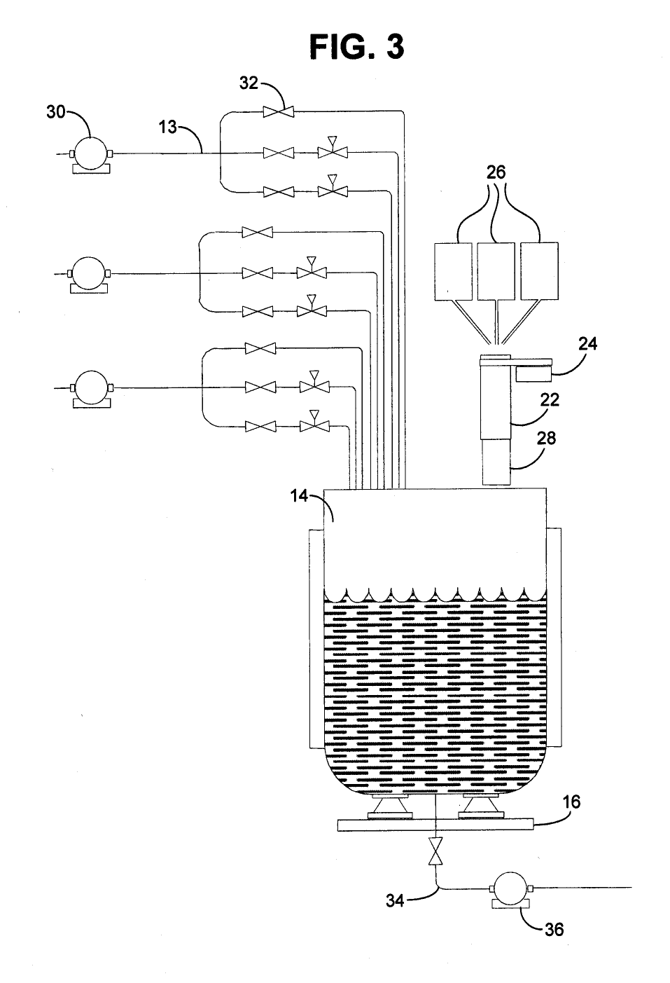

The liquid feeders 12 can be coupled to the mixing tank 14 via respective liquid conduits 13, as shown in FIG. 3. As also shown in FIG. 3, one or more pumps 30 and or valves 32 can be positioned along the conduits 13 to control the flow of the liquids into the mixing tank 14. The pumps 30 and/or the valves 32 can be controlled by the controller 18. The mixing tank 14 can be coupled to an outlet conduit 34, which can also include one or more valves and/or pumps 36, which can also be controlled by the controller 18 or another controller.

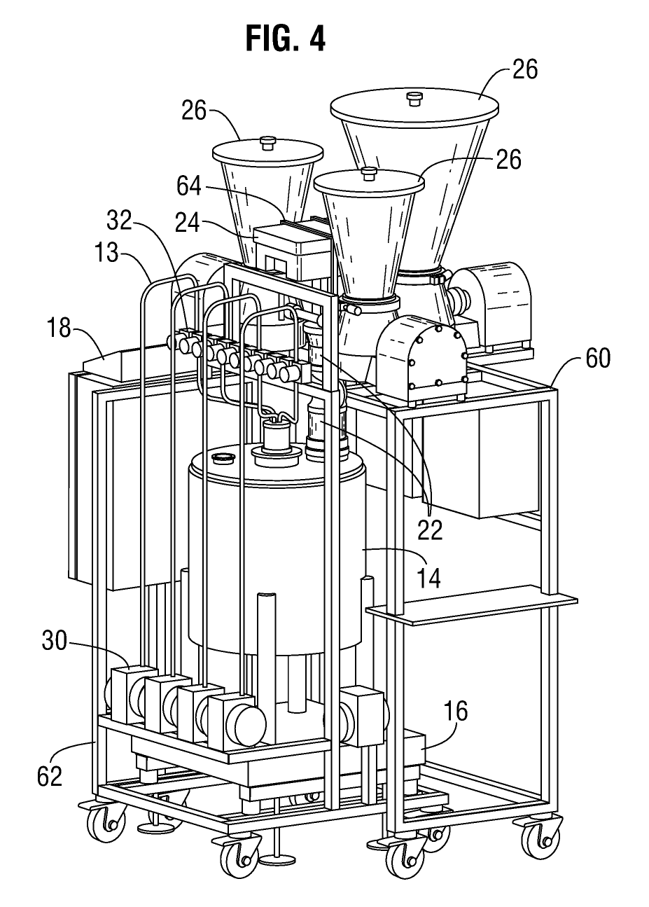

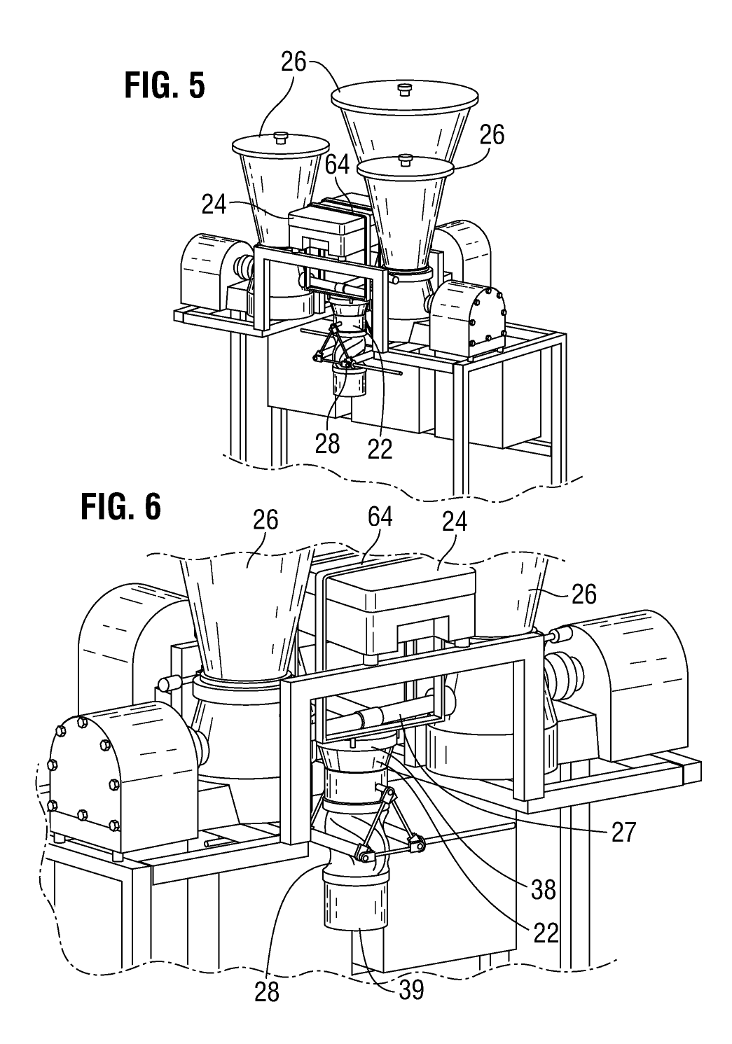

As shown in FIG. 4, the liquid dispensing system and the powder dispensing system can comprise separate assemblies that can be coupled together via the mixing tank 14, which can be part of the liquid dispensing system or the powder dispensing system. FIG. 4 shows the mixing tank 14 as part of the liquid dispensing system. The liquid dispensing system can be supported by a frame 62 and the powder dispensing system (shown separately in FIGS. 5 and 6) can be supported by a different frame 60. Both of the frames 60, 62 can be mounted on casters for mobility. The two systems can be separated, such as if only liquid is being mixed in the tank 14, or the two systems can be combined as shown in FIG. 4 by coupling the lower outlet of the powder hopper 22 to the mixing tank 14, and by coupling the controller 18, which is preferably mounted on the frame 62, to the components of the powder system.

As shown in FIGS. 4-6, the powder feeders 26, which can vary in size, and the powder hopper scale 24 are mounted on top of the frame 60. The powder hopper 22 and the valve 28 can be suspended below the scale 24, such as with brackets 64. As shown in FIG. 6, the powder feeders 26 can comprise a mechanism 27 for dispensing powders into a common upper inlet 38 of the hopper 22.

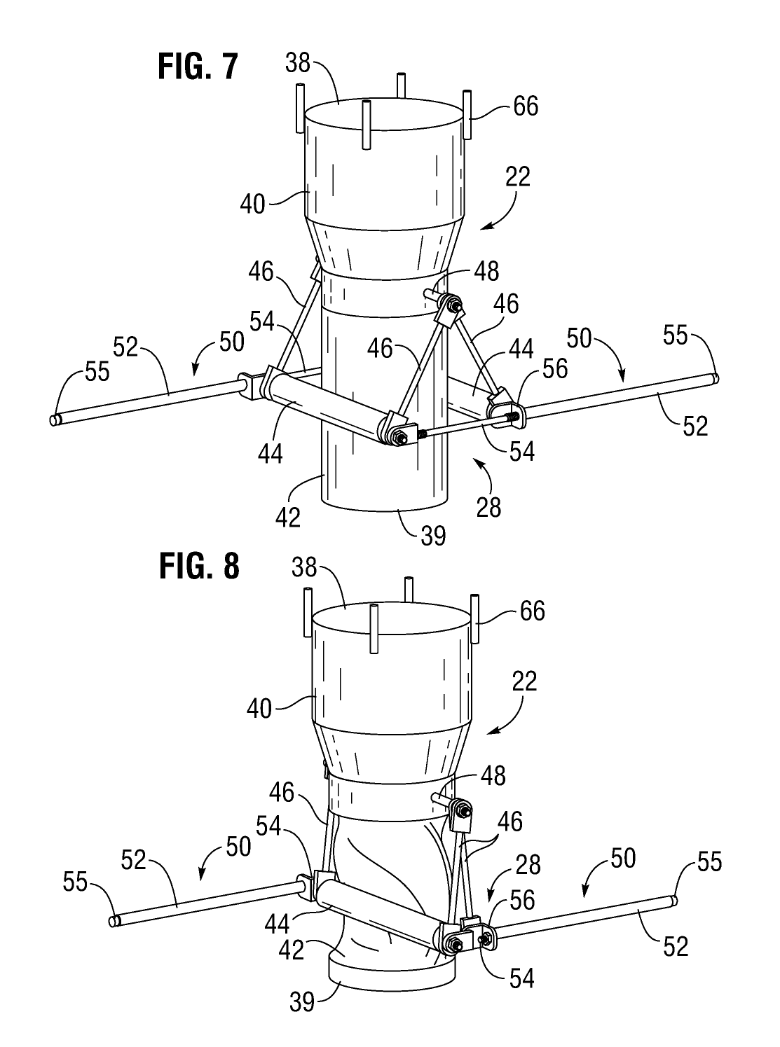

The powder hopper 22 can comprise a structure (shown in FIGS. 7 and 8 as being tubular, but other geometries are contemplated and can be implemented; in the following, a tubular geometry is assumed) comprising a rigid upper portion 40 having an upper inlet 38 for receiving powder and a flexible lower portion 42 extending below the rigid upper portion 40. The flexible lower portion 42 can have a lower outlet 39. An additional lower rigid portion extending below the flexible portion 42 can optionally be included to facilitate coupling the lower outlet to the mixing tank 14. The rigid upper portion 40 and the flexible lower portion 42 of the hopper 22 can define an internal passageway extending vertically between the upper inlet 38 and the lower outlet 39, thorough which powder can pass via gravity.

The rigid upper portion 40 can comprise connectors 66 for coupling the hopper 22 to the brackets 64. The upper portion 40 can be cylindrical or can be tapered, as shown in FIGS. 7 and 8. The shape of the rigid upper portion preferably does not limit the downward flow of powder through the internal passageway through the hopper 22.

The flexible lower portion 42 of the hopper 22 can comprise a generally cylindrical section of flexible material, such as a polymeric material. The material of the lower portion 42 is preferably durable and can withstand repeated pinching and releasing, has a low internal coefficient of friction and is not chemically reactive with the powder materials being dispensed.

The valve 28 can be coupled to the hopper 22, such as via the rigid upper portion 40, as shown in FIGS. 7 and 8. The valve 28 can comprise a pinch valve, such as the embodiment shown, or other type of valve operable to open and close the internal passageway through the hopper 22. The pinch valve 28 shown can comprise first and second clamping portions 44 positioned on opposite sides of the flexible lower portion 42 of the hopper and at least one actuator 50 operable to move the clamping portions 44 between an open position (shown in FIG. 7) and a closed position (shown in FIG. 8).

In the closed position, the clamping portions 44 are pressed tightly against opposite sides of the flexible lower portion 42 such that the flexible lower portion is collapsed and the internal passageway is blocked within the flexible lower portion, such that powder entering the internal passageway through the upper inlet 38 is contained within the hopper above the blocked portion of the internal passageway. In the open position, the clamping portions 44 are spaced sufficiently apart to allow the flexible lower portion 42 to be in a generally cylindrical configuration with the internal passageway open within the flexible lower portion 42, such that powder contained within the hopper falls though the flexible lower portion 42 and out through the lower outlet 39 into the mixing tank 14. To enable the flexible lower portion 42 to expand to the open cylindrical shape shown in FIG. 8, the flexible lower portion 42 can comprise a resiliently deformable material that can urge the lower portion 42, absent clamping forces from the valve 28, toward the cylindrical shape shown in FIG. 7. In some embodiments, the lower outlet 39 of the powder hopper can hang free and be spaced above the mixing tank 14 such that the flexible lower portion 42 can assume a natural cylindrical shape via gravity when the valve 28 is open.

As shown in FIGS. 7 and 8, the pinch valve 28 can further comprise at least a first arm 46 having an upper end pivotally coupled to the rigid upper portion 40 and a lower end coupled to the first clamping portion 44, and a second arm 46 having an upper end pivotally coupled to the rigid upper portion 40 and a lower end coupled to the second clamping portion 44. The upper ends of the first and second arms 46 can be pivotable about a common horizontal axis, which can pass diametrically through the rigid upper portion 40. In the embodiment shown, the pinch valve 28 further comprises third and a fourth arms 46 coupled at upper ends to the rigid upper portion 40 and lower ends coupled to the clamping portions 44. In this embodiment, the upper ends of the all four arms 46 can be pivotable about the same horizontal axis and all four arms can be the same length. As shown, the lower ends of two of the arms can coupled to opposite horizontal ends of the first clamping portion 44 and the lower ends of the other two arms can be coupled to opposite ends of the second clamping portion 44. The upper ends of the arms 46 can be pivotally coupled to the rigid upper portion 40 via horizontally aligned pivot pins 48 on opposite sides of the rigid upper portion 40. As the arms pivot about the horizontal axis of the pivot pins 48, the clamping members 44 travel in a common circular path on opposite sides of the flexible lower portion 42.

The two clamping portions 44 can comprise generally cylindrical bodies having parallel horizontal longitudinal axes extending between the lower ends of the arms 46. Each of the clamping portions can comprise a central rod extending through the cylindrical body between the lower ends of the arms 46, such that the cylindrical bodies can rotate freely about the central rods. This can reduce frictional wear between the cylindrical bodies and the flexible lower portion 40 when the valve 28 is closed and the cylindrical bodies collapse the flexible lower portion. In other embodiments, the cylindrical bodies can be fixed relative to the arms 46 such that they cannot rotate about their respective central axes.

The actuators 50 (shown as a pneumatic actuator) can be operable to adjust the distance between the clamping portions 44 and thereby open and close the valve 28. In some embodiments, the actuators 50 can comprise pneumatic actuators, as shown in FIGS. 7 and 8. In some embodiments, the actuators 50 can comprise electromechanical, hydraulic, magnetic, and/or other types of actuators. One of the actuators 50 can be positioned on each side of the clamping portions 44, such that each actuator is coupled to both of the clamping portions, as shown in FIGS. 7 and 8. The actuators 50 can comprise a cylindrical outer body 52 and a piston 54 positioned within the outer body and sharing a common longitudinal axis. The piston 54 and the outer body 52 are slidably movable relative to one another along the common longitudinal axis. The piston 54 can have a first end coupled to one of the clamping members 44 while its opposite end is engaged within the outer body 52. The outer body 52 can have a first end coupled to the other clamping member 44, such as via a bracket 56, and a second end 55, which for pneumatic actuators can be configured to be coupled to a pneumatic hose.

For pneumatic actuators 50, as air pressure is increased within the outer body 52, the piston 54 is pushed out of the outer body, increasing the distance between the first end of the piston and the first end of the outer body, and thereby moving the clamping members 44 apart from one another. Similarly, as air pressure is decreased within the outer body 52, the piston 54 is pulled into the outer body and the clamping members 44 are moved closer together, collapsing the flexible outer portion 42 of the hopper 22.

As shown in FIGS. 7 and 8, the actuators 50 can be positioned in a generally parallel horizontal arrangement and can have longitudinal axes that are generally perpendicular to the longitudinal axes of the clamping members 44 and the pivot pins 48. As the actuators 50 actuate the clamping members 44, the arms 46 rotate about the pivot pins 48, and the clamping members moving along a circular path. Accordingly, the actuators 50 and the clamping members 44 can be at a lowest position when the valve 28 is closed, as shown in FIG. 8, and can be at a highest position when the valve is in the open position, as shown in FIG. 7.

In use, the controller 18 can control the dispensing of one or more different powders from the powder feeders 26 into powder hopper 22 by sequentially dispensing each of the powders into the upper inlet 38 of the hopper with the valve 28 in the closed position. For each of the different powders, the controller 18 can use feedback from the scale 24 to precisely dispense a desired weight of powder into the hopper 22. For example, if one kilogram of each of two powders is to be dispensed from two different powder feeders 26 into the hopper 22, the controller 18 can control the dispensing of a first powder from a first of the powder feeders 26 into the hopper 22 such that the change in weight of the hopper 22 measured by the scale 24 is equal to one kilogram. After the first powder is dispensed into the hopper 22, the controller 18 can repeat the process with the second powder from the second powder feeder 26, dispensing the second powder into the hopper 22 until the change in weight of the hopper and its contents equals one kilogram.

After the desired amount of each powder is dispensed into the hopper 22, the controller can open the valve 28 and allow the powder in the hopper 22 to fall through the lower outlet 39 and into the tank 14 to be mixed with other components to form a desired mixture. Alternatively, each powder can be weighed in the hopper 22 and released into the tank 14 one at a time, such that the first powder is released into the tank prior to the second powder being dispensed into the hopper.

This exemplary method of dispensing powders can lead to greater precision because the total weight of the relatively light-weight hopper 22 plus the small amounts of the powders added to the hopper can be more precisely measured than the loss in weight of the much heavier powder feeders 26. Furthermore, only one scale 26 is needed, eliminating inconsistencies between plural different scales that would be needed to measure the loss in weight of each of the powder feeders 26, and reducing the space occupied by the dispensing system.

In another exemplary method, the controller 18 can dispense each powder in increasingly smaller increments from the power feeder 12 into the hopper 22 in order to increase precision. In such a method, the different powders can be dispensed one at a time in sequential order. For each of the different powders to be dispensed, the same process can be used to precisely dispense a desired amount of that powder. If a given mass of powder is to be dispensed into the mixing tank 14, the controller can allow a first portion of the given mass of powder to be dispensed into the hopper 22 based on an estimated flow rate of the powder out of the powder feeder 26. For example, if 10 grams of a powder is to be dispensed, the controller 18 can cause approximately 9 grams to be dispensed into the hopper by dispensing the powder at an estimated flow rate of 0.1 grams per second for 90 seconds. This first portion can be any percentage of the total mass to be dispensed, and is preferably at least 50% of the total mass. After the first portion is dispensed into the hopper 22, the change in weight of the hopper 22 and its contents can be determined via the scale 24. From this change in weight, the actual mass of the first portion of the powder dispensed into the hopper 22 can be determined. For example, if the change in weight of the hopper 22 after dispensing the first portion of the powder is measured to be 8.1 grams, then the actual mass dispensed can be determined to be 8.1 grams rather than the estimated 9 grams. Based on the actual mass dispensed, the estimated flow rate can be recalculated. For example, since only 8.1 grams were dispensed rather than the estimated 9 grams, the estimated flow rate can be adjusted from 0.10 grams per second to 0.09 grams per second. Using the adjusted estimated flow rate, a second portion of the total desired mass of the powder can be dispensed into the hopper 22. For example, if the second portion is 1.71 grams (90% of the remaining 1.9 grams to be dispensed), the controller 18 can dispense the powder at the adjusted estimated flow rate of 0.09 grams per second for 19 seconds. After the second portion is dispensed into the hopper 22, the change in weighed of the hopper 22 can be measured via the scale 24 and the actual mass of the second portion that was dispensed can be determined based on the change in weight of the hopper. Based on the determined actual mass of the second portion, the actual flow rate can again be calculated and the estimated flow rate can again be adjusted to match the actual flow rate. This process can be repeated until the actual mass of the powder dispensed into the hopper 22 is within a desired tolerance from the total desired mass of powder to be dispensed. Thereafter, the valve 28 can be opened to allow the powder in the hopper 22 to fall into the tank 14 to be mixed with other components in the tank.

The weight measured by the scale 24 can include the weight of the valve 28 in embodiments where the valve components are supported by the rigid upper portion 40 of the hopper 22, as is the case with the embodiments shown in FIGS. 7 and 8. In these embodiments, the weight measured by the scale 24 can include the weight pivot pins 48, the arms 46, the clamping portions 44 and the actuators 50. The total weight of the hopper 22 including these valve components, however, can be much less than the weight of the larger powder feeders 26, and therefore measuring the change in weight of the hopper 22 as power is added to the hopper can be more precise than measuring the loss in weight of the heavier powder feeders 26. In addition, only one scale 26 is needed, rather than a separate scale for each of the different power feeders.

Furthermore, measuring the change in weight of the hopper 22 with the scale 26 can be more precise than measuring the change in weight of the mixing tank 14 with the scale 16 because the hopper 22 and the dispensed powders in the hopper can weight significantly less than the larger mixing tank 14 and the various components in the tank. In addition, the liquid components dispensed from the liquid feeders 12 into the tank 14 are typically in larger volumes and heavier than the powders being mixed with the liquid in the tank. In one embodiment, the scale 24 can measure changes in weight of the hopper 22 as small as plus or minus about 0.1 grams, whereas the scale 16 can measure changes in weight of the mixing tank 14 as small as plus or minus about 5.0 grams. In other embodiments, the scales 16 and 24 can have various other precisions, but generally the scale 24 can be more precise than the scale 24 because the hopper 22 and dispensed powders it contains are much lighter than the mixing tank 14 and the mixture it contains. Thus, using the intermediate powder hopper 22 and the scale 26 to measure the mass of the dispensed powders can lead to more precise measurements of the powders as compared to relying on the change in weight of the mixing tank 14 to measure the mass of powder added to the tank.

After the various liquid and powder components have been dispensed into the mixing tank 14 and mixed together, the resulting batch can be tested for various properties to double check the accuracy of the dispensing procedures. For example, the pH and/or the electrical conductivity of the batch in the tank 14 can be tested. If the tested properties vary from predetermined ranges, then the batch can be disqualified. If the properties are within the predetermined ranges, then the batch can be qualified and the transferred to another container for later use.

In some embodiments, if the tested properties vary from the predetermined ranges, addition material can be added to the batch, such as more of one or more of the powders and/or liquids, until the tested properties of the batch are within the predetermined ranges. Such adjustments to a batch can comprise additions of very small amounts of powder, which can be enabled by the high precision of the disclosed powder dispensing system.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

We claim:

1. A system comprising:
a tank;
one or more liquid feeders coupled to the tank and configured to dispense one or more liquids into the tank;
a powder hopper comprising a powder inlet, a powder outlet, and a valve configured to open and close the powder outlet, the powder outlet being coupled to the tank for dispensing powder from the powder hopper into the tank;
one or more powder feeders coupled to the powder inlet of the powder hopper and configured to dispense one or more powders into the powder hopper;
a first measuring device configured to measure the amount of powder dispensed into the powder hopper;
a second measuring device coupled to the tank and configured to measure the amount of the liquids dispensed into the tank; and
a control system configured to control the dispensing of liquids from the liquid feeders into the tank based at least in part on the measurements from the second measuring device, to control the dispensing of the powders from the powder feeders based at least in part on the measurements from the first measuring device, and to control actuation of the valve.

2. The system of claim 1, wherein the first measuring device comprises a first weighing device configured to measure the mass of powder dispensed into the powder hopper and the second measuring device comprises a second weighing device configured to measure the mass of the liquids dispensed into the tank.

3. The system of claim 2, wherein the powder hopper is suspended below the first weighing device.

4. The system of claim 1, further comprising an analytical device for measuring at least one property of the mixture in the tank, the analytical device providing an output signal that is in communication with the control system.

5. The system of claim 1, wherein the powder hopper is configured to receive powder from the powder feeders with the valve closed until the total mass of the received powder reaches a predetermined value, and then dispense the received powder into the tank when the valve is opened.

6. The system of claim 1, wherein the valve comprises a pinch valve configured to collapse a flexible portion of the powder hopper to prevent the flow of powder therethrough.

7. The system of claim 6, wherein the pinch valve comprises a pair of substantially parallel, horizontally disposed clamping members positioned on opposite sides of the flexible portion and at least one actuator configured to move the clamping members toward each other to collapse the flexible portion between the clamping members.

8. The system of claim 7, wherein the clamping members are pivotally coupled to a rigid portion of the powder hopper such that the clamping members are pivotable about a common horizontal axis.

9. The system of claim 8, wherein the first measuring device is configured to measure the mass of the pinch valve along with the rigid portion of the powder hopper and the flexible portion of the powder hopper.

10. A powder hopper, comprising:
a structure comprising a rigid upper portion having an upper inlet for receiving powder, the structure further comprising a flexible lower portion extending below the rigid upper portion, the flexible lower portion having a lower outlet, the structure defining an internal passageway extending vertically through the structure from the upper inlet to the lower outlet; and
a pinch valve coupled to the structure, the pinch valve comprising first and second clamping portions positioned on opposite sides of the flexible lower portion of the structure and at least one actuator operable to move the clamping portions between an open position and a closed position;
wherein in the closed position the clamping portions are pressed tightly against opposite sides of the flexible lower portion such that the flexible lower portion is collapsed and the internal passageway is blocked within the flexible lower portion, such that powder entering the internal passageway through the upper inlet is contained within the structure above the blocked portion of the internal passageway; and
wherein in the open position the clamping portions are spaced sufficiently apart to allow the flexible lower portion to be in a generally cylindrical configuration with the internal passageway open within the flexible lower portion, such that powder contained within the structure falls though the flexible lower portion and out through the lower outlet.

11. The powder hopper of claim 10, further comprising a weighing device positioned above the structure, the structure and the pinch valve being suspended from the weighing device, the weighing device configured to measure the combined mass of the structure, the pinch valve, and any powder contained within the structure.

12. The powder hopper of claim 10, wherein the pinch valve is coupled to the rigid upper portion of the structure.

13. The powder hopper of claim 12, wherein the pinch valve further comprises at least a first arm having an upper end pivotally coupled to the rigid upper portion and a lower end coupled to the first clamping portion, and a second arm having an upper end pivotally coupled to the rigid upper portion and a lower end coupled to the second clamping portion, the upper ends of the first and second arms being pivotable about a common horizontal axis passing diametrically through the rigid upper portion.

14. The powder hopper of claim 13, wherein the pinch valve further comprises a third arm having an upper end pivotally coupled to the rigid upper portion and a lower end coupled to the first clamping portion, and a fourth arm having an upper end pivotally coupled to the rigid upper portion and a lower end coupled to the second clamping portion, the upper ends of the third and fourth arms being pivotable about the same horizontal axis as the upper ends of the first and second arms, the lower ends of the first and third arms being coupled to opposite horizontal ends of the first clamping portion and the lower ends of the second and fourth arms being coupled to opposite ends of the second clamping portion.

15. The powder hopper of claim 14, wherein the first, second, third and fourth arms are substantially the same length.

16. The powder hopper of claim 10, wherein the first clamping portion comprises a first substantially cylindrical body having a first horizontal axis and the second clamping portion comprises a second substantially cylindrical body having a second horizontal axis, the first and second axes being substantially parallel and substantially equal in vertical position in both the open position and the closed position.

17. The powder hopper of claim 10, wherein the at least one actuator comprises a first actuator and a second actuator, the first actuator being coupled to a first side end of the first clamping portion and a first side end of the second clamping portion and operable to vary the distance between the first side ends of the first and second clamping portions, the second actuator being coupled to a second, opposite side end of the first clamping portion and a second, opposite side end of the second clamping portion and operable to vary the distance between the second side ends of the first and second clamping portions.

18. The powder hopper of claim 17, wherein the first and second actuators are configured to actuate in tandem such that the first and second clamping portions remain generally parallel to one another as they move between the open and closed positions.

19. A method for dispensing materials, the method comprising:
dispensing a predetermined volume of at least one liquid into a tank from at least one bulk liquid source;
closing an outlet valve of a powder hopper by pinching a flexible portion of the powder hopper such that powder is prevented from flowing through the flexible portion;
dispensing at least one powder into the powder hopper from at least one bulk powder source;
weighing the powder hopper and the powder dispensed into the powder hopper to determine the mass of the powder;
opening the outlet valve by releasing compression pressure on the flexible portion of the powder hopper to allow the powder in the powder hopper to fall into the tank to form a mixture with the at least one liquid; and
determining that at least one property of the mixture in the tank is within a predetermined range.

20. The method of claim 19, wherein dispensing a predetermined amount of at least one liquid into the tank comprises:
determining the predetermined volume of the liquid to be dispensed into the tank based on the mass of the powder to be mixed with the liquid in the tank;
dispensing a first portion of the predetermined volume of the liquid into the tank based on an estimated flow rate of the liquid into the tank;
determining the volume of the first portion by measuring the weight of the first portion within the tank;
determining an actual flow rate of the liquid into the tank based on the determined volume of the first portion;
adjusting the estimated flow rate based on the determined actual flow rate; and
dispensing a second portion of the predetermined volume of the liquid into the tank based on the adjusted estimated flow rate.
